(19) United States
(12) Patent Application Publication
(10) Pub. No.: US 2006/0029794 A1
(43) Pub. Date: Feb. 9, 2006

(54) Hardcoat laminate

(75) Inventors: Koichi Mikami, Tokyo-To (JP); Norinaga Nakamura, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/084,733

(22) Filed: Mar. 18, 2005

(30) Foreign Application Priority Data
Mar. 31, 2004 (JP) 2004-105827

(51) Int. Cl. B32B 5/16; B32B 19/00; B32B 15/04; C08J 7/04; B32B 9/00; B05D 5/06

(52) U.S. Cl. 428/328; 428/457; 428/702; 428/698; 428/341; 427/162

(57) ABSTRACT

Disclosed in a hard coat laminate with improved anti-dust-adhesion properties. The hard coat laminate comprises: a light transparent substrate; and an electrically conductive layer and a hard coat layer provided in that order on the light transparent substrate, the saturated amount of electrification on the outermost surface of the hard coat laminate being not more than 1.5 kV.

### TECHNICAL FIELD

The present invention relates to a hard coat laminate with improved anti-dust adhesion.

### BACKGROUND ART

In image display devices such as liquid crystal displays (LCDs) or cathode-ray tube display devices (CRTs), the display surface is required to reduce reflection of light applied from external light sources such as fluorescent lamps and thus to enhance visibility. To meet this requirement, a hard coat laminate comprising an electrically conductive layer and a hard coat layer provided in that order on a light transparent substrate has been used to reduce the reflecting properties of the display surface of the image display device and thus to improve visibility.

For example, as proposed in Japanese Patent Laid-Open No. 202408/2003, the hard coat laminate utilized as an antireflective laminate is produced by stacking a hard coat layer on a surface of a light transparent substrate. For some conventional hard coat laminates, however, the outermost surface is disadvantageously electrified, often resulting in dust adhesion on the outermost surface.

For this reason, at the present time, the development of a hard coat laminate having anti-dust adhesion and mechanical strength has been demanded.

### RELATED APPLICATIONS

This application is a patent application claiming priority based on Japanese Patent Application No. 105827/2004 (Japan), and the specification of this application includes the contents of this patent application.

### SUMMARY OF THE INVENTION

The present inventors have now found that the anti-dust adhesion on the outermost surface of the hard coat layer can be significantly improved by adding a conductive agent to bring the outermost surface of the hard coat layer to a specific saturated amount of electrification. The present invention has been made based on such finding.

Accordingly, an object of the present invention is to provide a hard coat laminate which has anti-dust adhesion on the outermost surface of the hard coat laminate and has excellent mechanical strength by bringing the saturated amount of electrification on the outermost surface of the hard coat laminate to a specific value in stacking an electrically conductive layer and a hard coat layer and any desired layer onto a surface of a light transparent substrate.

Thus, according to one aspect of the present invention, there is provided a hard coat laminate comprising: a light transparent substrate; and an electrically conductive layer and a conductive agent-containing hard coat layer provided in that order on said light transparent substrate,

the saturated amount of electrification on the outermost surface of said hard coat laminate being not more than 1.5 kV.

According to another aspect of the present invention, there is provided a process for producing a hard coat laminate comprising: a light transparent substrate; and an electrically conductive layer and a conductive agent-containing hard coat layer provided in that order on said light transparent substrate, said process comprising the steps of:

forming an electrically conductive layer on a surface of said light transparent substrate; and

applying a liquid composition, for hard coat layer formation, containing a conductive agent on said electrically conductive layer to form a hard coat layer, the saturated amount of electrification on the outermost surface of said hard coat laminate being brought to not more than 1.5 kV.

### BEST MODE FOR CARRYING OUT THE INVENTION

Hard Coat Laminate

Outermost Surface of Hard Coat Laminate

The outermost surface of the hard coat laminate according to the present invention has been brought to a saturated amount of electrification of not more than 1.5 kV, preferably not more than 0.6 kV, more preferably 0 kV. When the saturated amount of electrification is the above-defined value, the dust adhesion on the outermost surface of the hard coat laminate can be effectively prevented.

In the present invention, the saturated amount of electrification can be measured according to JIS L1094, for example, by a half value measurement method. This method can be carried out with a commercially available measuring device, for example, with a honestmeter H-0110 (Shishido Electrostatic, Ltd.). One example of a method for measuring the saturated amount of electrification using this measuring device will be described.

A sample (4 cm×4 cm) is fixed onto a turn table and is rotated, a voltage is applied, and the withstand voltage (kV) is measured for the surface of the sample with this measuring device. A curve for attenuation of withstand voltage over time is prepared to determine the half value period (time elapsed until the amount of electrification reaches the half of the initial value) and the saturated amount of electrification.

1) Hard Coat Layer

The hard coat layer is formed from the viewpoint of imparting properties such as scratch resistance and strength to the laminate per se and, in the present invention, contains a conductive agent. The term “hard coat layer” as used herein refers to a hard coat layer having a hardness of “H” or higher as measured by a pencil hardness test specified in JIS 5600-5-4:1999.

Basic Material

The hard coat layer is preferably formed using an ionizing radiation curing resin composition. More preferably, ionizing radiation curing resins usable herein include resins having an (meth)acrylate functional group, for example, relatively low-molecular weight polyester resins, polyether resins, acrylic resins, epoxy resins, urethane resins, alkyd resins, spiroacetal resins, polybutadiene resins, and polythiol-polyether resins, polyhydric alcohols, di(meth)acrylates, such as ethylene glycol di(meth)acrylate and pentaerythritol di(meth)acrylate monostearate; monomers as polyfunctional compounds, for example, tri(meth)acrylates, such as trimethylolpropane tri(meth)acrylate and pentaerythritol tri(meth)acrylate, pentaerythritol tetra(meth)acrylate derivatives, and dipentaerythritol penta(meth)acrylate, and oligomers such as epoxy acrylate or urethane acrylate.

Conductive Agent

The hard coat layer preferably contains a conductive agent. The addition of the conductive agent can reduce the saturated amount of electrification on the outermost surface of the hard coat laminate, and, thus, good anti-dust adhesion can be imparted to the outermost surface.

Specific examples of conductive agents include those usable in a conductive layer which will be described later, for example, metals, metal oxides (silica), metal nitrides, metal carbides, metal alkoxides, carbon compounds, or carbonaceous compounds (carbon black), organic compounds or mixtures thereof, preferably those in the form of fine particles. Specific examples of preferred metals (fine particles) include fine particles of gold and fine particles of nickel, more preferably fine particles of gold. Specific examples organic compounds include polyethylenedioxythiophene polystyrol sulphonate (PEDT/PSS), poly-p-phenylenevinylene, poly-2,5-dialkyl-p-phenylenevinylene, poly-2,5-dialkoxy-p-phenylenevinylene, poly-2,5-thienylenevinylene, polyaniline, polyaniline derivatives, and polyethylenedioxythiophene.

When the conductive agent is added as fine particles, the average primary particle diameter of the fine particles is not less than 10 nm and not more than 15 μm. Preferably, the lower limit of the average primary particle diameter is 100 nm, and the upper limit of the average primary particle diameter is 7 μm. The amount of the conductive agent added is not less than 0.005% by weight and not more than 70% by weight based on the total weight of the hard coat layer. Preferably, the lower limit of the addition amount is 0.01% by weight, and the upper limit of the addition amount is 30% by weight.

Formation of Hard Coat Layer

The hard coat layer may be formed by mixing the above resin and optionally a conductive agent in a suitable solvent, for example, toluene, xylene, cyclohexane, ethyl acetate, butyl acetate, propyl acetate, methyl ethyl ketone (MEK), and methyl isobutyl ketone (MIBK), to prepare a liquid composition which is then coated onto a transparent substrate.

In a preferred embodiment of the present invention, a leveling agent, for example, a fluorine or silicone leveling agent, is added to the liquid composition. In the liquid composition with the leveling agent added thereto, upon coating or drying of the coating, the inhibition of curing by oxygen on the surface of the coating can be effectively prevented, and, at the same time, the anti-scratch effect can be imparted. The leveling agent is preferably utilized in transparent substrates in a film form where heat resistance is required (for example, triacetylcellulose).

Methods usable for coating the liquid composition include roll coating, Mayer-bar coating, and gravure coating. After coating of the liquid composition, drying and ultraviolet curing are carried out.

Specific examples of ultraviolet light sources include light sources such as ultrahigh pressure mercury lamps, high pressure mercury lamps, low pressure mercury lamps, carbon arc lamps, blacklight fluorescent lamps, and metal halide lamps. The wavelength of the ultraviolet light may be in a wavelength range of 190 to 380 nm. Specific examples of electron beam sources include various electron beam accelerators, for example, Cockcroft-Walton, van de Graaff, resonance transformer, insulated core transformer, linear, dynamitron, and high-frequency electron beam accelerators.

The coverage of the liquid composition for hard coat layer formation on the surface of the electrically conductive layer is not less than 3.0 g/m². The thickness of the hard coat layer (cured state) may be properly determined by taking into consideration, for example, mechanical strength of the hard coat laminate. The saturated amount of electrification on the outermost surface of the hard coat laminate can be reduced by regulating the coverage and layer thickness as described above, to impart good anti-dust adhesion to the outermost surface.

2) Electrically Conductive Layer (Antistatic Layer)

The electrically conductive layer (antistatic layer) is formed on the surface of a light transparent substrate. Specific examples of methods usable for forming an electrically conductive layer are one in which a vapor-deposited film is formed by vapor-depositing or sputtering an electrically conductive metal, an electrically conductive metal oxide or the like onto the surface of a light transparent substrate or one in which a coating is formed by coating a coating liquid comprising a conductive agent dispersed in a resin onto the surface of a light transparent substrate.

When the electrically conductive layer is formed as a vapor-deposited film, examples of electrically conductive metals or electrically conductive metal oxides include antimony-doped indium tin oxide (hereinafter referred to as “ATO”) and indium tin oxide (hereinafter referred to as “ITO”). The thickness of the vapor-deposited film as the electrically conductive layer is not less than 10 nm and not more than 300 nm. Preferably, the upper limit of the thickness is 100 nm, and the lower limit of the thickness is 50 nm.

When a coating is formed using a coating liquid containing a conductive agent, specific examples of conductive agents include conductive fine particles of a metal or a metal oxide or an organic compound, for example, fine particles of antimony-doped indium tin oxide (hereinafter referred to as “ATO”), indium tin oxide (hereinafter referred to as “ITO”), and organic compounds which had been surface treated with gold and/or nickel. The amount of the conductive agent added is not less than 5% by weight and not more than 70% by weight based on the total amount of the coating liquid for an electrically conductive layer. Preferably, the lower limit of the addition amount is 15% by weight, and the upper limit of the addition amount is 60% by weight. More preferably, the lower limit of the addition amount is 25% by weight, and the upper limit of the addition amount is 50% by weight.

Preferred resins are transparent, and three types of resins, that is, ionizing radiation curing resins which are curable by ultraviolet light or electron beam irradiation, mixtures of ionizing radiation curing resins with solvent drying type resins, or heat-curing resins, may be mentioned as specific examples of this resin.

Ionizing Radiation Curing Resin

Specific examples of ionizing radiation curing resins include resins having an acrylate functional group, and examples thereof include relatively low-molecular weight polyester resins, polyether resins, acrylic resins, epoxy resins, urethane resins, alkyd resins, spiroacetal resins, polybutadiene resins, and polythiol-polyene resins, oligomers or prepolymers of (meth)acrylate or the like of polyfunctional compounds, such as polyhydric alcohols, and ionizing radiation curing resins containing a reactive diluent. Reactive diluents usable herein include monofunctional monomers, such as ethyl(meth)acrylate, ethylhexyl(meth)acrylate, styrene, methyl styrene, and N-vinylpyrrolidone, and polyfunctional monomers, for example, polymethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

When the ionizing radiation curing resin is used as the ultraviolet curing resin, the use of a photopolymerization initiator is preferred. Specific examples of photopolymerization initiators include acetophenones, benzophenones, Michler's benzoyl benzoate, α-amyloxime esters, tetramethylthiuram monosulfide, and thioxanthones. Further, the use of a mixture of the photopolymerization initiator with a photosensitizer is preferred. Specific examples thereof include n-butylamine, triethylamine, and poly-n-butylphosphine.

Solvent Drying Type Resin

Main solvent drying type resins usable as a mixture with the ionizing radiation curing resin are thermoplastic resins which are commonly described and used in the art. The addition of the solvent drying type resin can effectively prevent defects of coating of the coated face.

In a preferred embodiment of the present invention, when the material for the light transparent substrate is a cellulosic resin such as TAC, specific examples of preferred thermoplastic resins include cellulosic resins, for example, nitrocellulose, acetylcellulose, cellulose acetate propionate, and ethylhydroxyethylcellulose. The use of the cellulosic resin can improve the adhesion between the light transparent substrate and the electrically conductive layer and the transparency.

Heat Curable Resins

Specific examples of heat curable resins include phenolic resins, urea resins, diallyl phthalate resins, melamine resins, guanamine resins, unsaturated polyester resins, polyurethane resins, epoxy resins, aminoalkyd resins, melamine-urea co-condensed resins, silicone resins, and polysiloxane resins. When heat curable resins are used, if necessary, crosslinking agents, curing agents such as polymerization initiators, polymerization accelerators, solvents, viscosity modifiers and the like may be further added.

When the coating is formed as the electrically conductive layer, a coating liquid (a liquid composition) containing a mixture of the above resin with the above electrically conductive fine particles can be coated by a coating method such as roll coating, Mayer-bar coating, or gravure coating. After coating of the coating liquid, drying and ultraviolet curing are carried out.

The ionizing radiation curing resin composition is cured by irradiation with an electron beam or ultraviolet light. In the case of electron beam curing, for example, electron beams having an energy of 100 to 300 KeV are used. On the other hand, in the case of ultraviolet curing, for example, ultraviolet light emitted from light sources such as ultrahigh pressure mercury lamps, high pressure mercury lamps, low pressure mercury lamps, carbon arc, xenon arc, and metal halide lamps, are utilized.

The thickness of the coating as the electrically conductive layer is not less than 0.05 μm and not more than 4 μm. Preferably, the lower limit of the thickness is 0.1 μm, and the upper limit of the thickness is 1 μm.

3) Transparent Substrate

Preferably, the transparent substrate is transparent, smooth, and resistant to heat and has excellent mechanical strength. Specific examples of the material for constituting the transparent substrate include thermoplastic resins such as triacetylcellulose, polyester, cellulose triacetate, cellulose diacetate, cellulose acetate butyrate, polyester, polyamide, polyimide, polyether sulfone, polysulfone, polypropylene, polymethyl pentene, polyvinyl chloride, polyvinyl acetal, polyether ketone, polymethyl methacrylate, polycarbonate, and polyurethane. Preferred are triacetylcellulose, polyesters, and cellulose triacetate.

In the present invention, these thermoplastic resins are used as a thin, highly flexible film. Depending upon embodiments where curing properties are required, plates of thermoplastic resins or glass plates may also be used.

The thickness of the transparent substrate is not less than 20 μm and not more than 300 μm. Preferably, the upper limit of the thickness is 200 μm, and the lower limit of the thickness is 30 μm. When the transparent substrate is in a plate form, the thickness may exceed the above upper limit.

4) Optional Layer (Low Refractive Index Layer)

In a preferred embodiment of the present invention, the low refractive index layer is provided on the outermost surface of the hard coat layer. In the present invention, “low refractive index layer” refers to a layer having a refractive index of less than 1.5, preferably not more than 1.45. The hard coat laminate provided with a low refractive index layer imparts an antireflective effect.

The low refractive index layer may also be formed by other conventional thin film forming means, for example, vacuum deposition, sputtering, reactive sputtering, ion plating, electroplating or other suitable means. Further, the low refractive index layer may also be formed by coating a coating liquid comprising a low refraction agent dispersed in a resin. In the latter case, fine particles are used as the low refraction agent, and a resin is used as a binder. The fine particles and the binder will be described in detail.

Fine Particles

The fine particles may be either inorganic or organic fine particles, for example, fine particles of metals, metal oxides, and plastics, preferably fine particles of silicon oxide (silica). The fine particles of silica can impart a desired refractive index while suppressing an increase in refractive index of the binder. The fine particles of silica may in any form, for example, may be in the form of crystal, sol, or gel. Fine particles of silica may be a commercially available product. For example, Aerosil manufactured by Degussa Co., Ltd. and colloidal silica manufactured by Nissan Chemical Industries Ltd. are preferred.

The average particle diameter of the fine particles is not less than 5 nm and not more than 300 nm. Preferably, the lower limit of the average particle diameter is 10 nm, and the upper limit of the average particle diameter is 100 nm. More preferably, the lower limit of the average particle diameter is 20 nm, and the upper limit of the average particle diameter is 80 nm. When the average particle diameter of the fine particles is in the above-defined range, excellent transparency can be imparted to the low refractive index layer.

Binder

The binder comprises, as an indispensable component, a monomer containing three or more functional groups per molecule and curable by an ionizing radiation. The monomer used in the present invention contains a functional group curable by an ionizing radiation (hereinafter often referred to as “ionizing radiation curable group”) and a functional group curable by heat (hereinafter often referred to as “heat curable group”). Therefore, the coating can be efficiently cured by coating the monomer-containing composition (coating liquid) on a surface of an object, drying the coating, and then applying an ionizing radiation to the coating, or applying an ionizing radiation with heating to easily form a chemical bond such as a crosslinked bond within the coating film. The binder may be the same as the resin explained above in connection with the electrically conductive layer.

When the low refractive index layer is formed using a coating liquid, a coating liquid having a modified viscosity is prepared by optionally mixing a suitable solvent in the fine particles and the binder. In this case, an antireflection film having an excellent capability of reflecting visible light can be realized, and a thin film which is even, that is, free from uneven coating, can be formed. Further, a refractive index layer which is particularly excellent in adhesion to the substrate can be formed. When heating means is used as the curing means, preferably, a thermal polymerization initiator which, upon heating, generates, e.g., radicals to initiate polymerization of the polymerizable compound is added. The resin curing means may be the same as that described above in connection with the electrically conductive layer.

The thickness of the low refractive index layer is not less than 20 nm and not more than 800 nm. Preferably, the upper limit of the thickness is 400 nm, and the lower limit of the thickness is 50 nm.

Applications of Hard Coat Laminate

The hard coat laminate according to the present invention may be utilized in antistatic films, scratch resistant films, or antireflective laminates. Further, the hard coat laminate is usable in transmission display devices. In particular, the hard coat laminate according to the present invention can be used in displays such as televisions, computers, word processors and the like, especially on the surface of displays for high definition images, such as CRT and liquid crystal panels.

### EXAMPLES

The following Examples further illustrate the contents of the present invention. The present invention, however, is not to be construed as being limited thereto.

Preparation of Coating Liquids

Coating liquid for electrically conductive layer

| | | |
|---|---|---|
| ATO dispersion (PELTRON C-4456S-7, | 2.5 | kg |
| manufactured by NIPPON PELNOX CORP.) | | |
| Photocurable resin liquid (KS-HDDA, | 1.05 | kg |
| manufactured by Nippon Kayaku Co., Ltd.) | | |
| Polymerization initiator (Irgacure 184, | 84 | kg |
| manufactured by Ciba-Geigy Limited) | | |
| Butyl acetate | 7.65 | kg |
| (manufactured by The Inctec Inc.) | | |
| Cyclohexanone | 3.28 | kg |
| (manufactured by The Inctec Inc.) | | |

Coating liquid for hard coat layer

| | | |
|---|---|---|
| Photocurable resin liquid (clear hard coat | 4.32 | kg |
| (80) MEK, manufactured by The Inctec Inc.) | | |
| Photocurable resin PETA (PET-30, | 2.18 | kg |
| manufactured by Nippon Kayaku Co., Ltd.) | | |
| Fine particles of gold | 2.18 | g |
| (average particle diameter 5 μm) | | |
| Methyl ethyl ketone | 1.32 | kg |
| (manufactured by The Inctec Inc.) | | |
| Cyclohexanone | 3.47 | kg |
| (manufactured by The Inctec Inc.) | | |
| Methyl isobutyl ketone | 1.37 | kg |
| (manufactured by The Inctec Inc.) | | |
| Fluorine leveling agent (MCF-350-5, | 100 | kg |
| manufactured by DIC) | | |

Coating liquid for low refractive index layer

| | | |
|---|---|---|
| 20% hollow silica sol (IPA, manufactured by | 14.67 | kg |
| Catalysts and Chemicals Industries Co., Ltd) | | |
| Surfactant-type antistatic agent | 0.24 | kg |
| (Staticide, manufactured by Mitsui Bussan | | |
| Plastics Co., Ltd.) | | |
| Photocurable resin (PETA) | 1.71 | kg |
| Polymerization initiator (Irgacure 907, | 0.11 | kg |
| manufactured by Ciba-Geigy Limited) | | |
| Methyl isobutyl ketone | 83.26 | kg |
| (manufactured by The Inctec Inc.) | | |

Formation of Hard Coat Laminate

### (1) Examples 1 to 7

The coating liquid for an electrically conductive layer was bar coated on an 80 μm-thick thin film of triacetate cellulose (TAC) (a light transparent substrate). The coating was dried to remove the solvent. The dried coating was then irradiated with ultraviolet light at an exposure of 30 mJ/cm² with an UV irradiation apparatus (Fusion UV Systems Japan KK; Bulb) to cure the coating. As shown in Table 1, the electrical conductivity (surface resistivity) of the electrical conductive layer in Example 6 and Comparative Example 10 are different from that in the other examples and comparative examples. This was varied by varying the coating thickness by bar coating.

Next, the coating liquid for a hard coat layer was bar coated on the surface of the electrically conductive layer. The coating was dried to remove the solvent. Thereafter, the dried coating was irradiated with ultraviolet light at an exposure of 30 mJ/cm² with an UV irradiation apparatus (Fusion UV Systems Japan KK; H bulb) to cure the coating. Thus, a desired hard coat laminate was prepared. In Examples 1 to Comparative Example 3, the coverage of the hard coat layer was varied by varying the count of Mayer bar in the bar coating.

### (2) Example 8

A coating liquid for a low refractive index layer was bar coated on the surface of the hard coat layer, and the coating was dried to remove the solvent. The dried coating was then irradiated with ultraviolet light at an exposure of 200 mJ/cm² with an UV irradiation apparatus (Fusion UV Systems Japan KK; H bulb) to cure the coating. Thus, a hard coat laminate with a 100 nm-thick low refractive index layer of Example 8 was prepared.

Evaluation Tests

The following evaluation tests were carried out for the hard coat laminates of Examples 1 to 8 and Comparative Examples 1 to 3. The results of the evaluation tests were as shown in Table 1 below.

Evaluation 1: Test on Saturated Amount of Electrification

A voltage of +10 kV was applied to a position distant by 20 mm from the backside of the hard coat laminate with a honestmeter H-0110 (Shishido Electrostatic, Ltd.). When the electrified state became a saturated electrified state, the application of the voltage was stopped and the saturated amount of electrification was rapidly measured. The smaller the saturated amount of electrification, the better the anti-dust adhesion.

Evaluation 2: Test on Anti-Dust Adhesion

A test disk for installing a hard coat laminate was provided at a position of about 10 mm above a table on which 10 g of cigarette ash (average particle diameter: approximately a few micrometers to a few millimeters) had been evenly dispersed. In the same manner as in evaluation 1, the voltage was applied to the hard coat laminate, and, when the state of electrification reached a saturated electrified state, the hard coat laminate was installed on the test disk to examine whether or not the cigarette ash is adhered on the surface of the hard coat laminate. The results were evaluated according to the following criteria.

Evaluation Criteria

◯: Cigarette ash was not adhered.

X: Cigarette ash was adhered.

Evaluation 3: Evaluation of Strength (Hardness)

Evaluation Criteria

The hardness of each hard coat laminate was expressed in terms of pencil hardness. The pencil hardness was measured according to JIS K 5400. The results were evaluated according to the following criteria.

◯: Strength was H2 or higher.

X: Strength was lower than H2.

Evaluation 4: Measurement of Surface Resistivity

The surface resistivity of the outermost surface of each hard coat laminate was measured by pressing an HR probe of Hiresta IP MPC-HT260 (manufactured by Mitsubishi Chemical Corporation) against the film surface.

TABLE 1

| | | | | Evaluation of test | | | |
|---|---|---|---|---|---|---|---|
| | Electrical | Coverage | | | | | Surface |
| | conductivity | of HC | Low | Saturated | | | resistivity |
| | of AS layer | layer | refractive | withstanding | Anti-dust | Hardness | of laminate |
| | (Ω/□) | (g/m2) | index layer | voltage (kV) | adhesion | (2H) | (Ω/□) |
| Ex. 1 | 8.00E+07 | 3.0 | Not | 0.35 | ◯ | ◯ | 3.20E+08 |
| | | | provided | | | | |
| Ex. 2 | 8.00E+07 | 4.5 | Not | 0.66 | ◯ | ◯ | 4.08E+08 |
| | | | provided | | | | |
| Ex. 3 | 8.00E+07 | 5.5 | Not | 0.89 | ◯ | ◯ | 1.14E+09 |
| | | | provided | | | | |
| Ex. 4 | 8.00E+07 | 6.0 | Not | 0.95 | ◯ | ◯ | 4.95E+09 |
| | | | provided | | | | |
| Ex. 5 | 8.00E+07 | 7.0 | Not | 1.21 | ◯ | ◯ | 9.80E+12 |
| | | | provided | | | | |
| Ex. 6 | 4.50E+10 | 7.0 | Not | 1.45 | ◯ | ◯ | 9.00E+12 |
| | | | provided | | | | |
| Ex. 7 | 8.00E+07 | 8.5 | Not | 1.48 | ◯ | ◯ | 9.80E+12 |
| | | | provided | | | | |
| Ex. 8 | 8.00E+07 | 7.5 | Provided | 1.32 | ◯ | ◯ | |
| Comp. | 8.00E+07 | 2.5 | Not | 0.14 | ◯ | X | 2.40E+08 |
| Ex. 1 | | | provided | | | | |
| Comp. | 8.00E+07 | 8.0 | Not | 1.57 | X (*1) | ◯ | Immeasurable |
| Ex. 2 | | | provided | | | | |
| Comp. | 1.00E+12 | 6.0 | Not | 1.62 | ◯ | ◯ | Immeasurable |
| Ex. 3 | | | provided | | | | |

(*1) Very small amount

1. A hard coat laminate comprising: a light transparent substrate; and an electrically conductive layer and a hard coat layer provided in that order on said light transparent substrate,
the saturated amount of electrification on the outermost surface of said hard coat laminate being not more than 1.5 kV.

2. The hard coat laminate according to claim 1, wherein said hard coat layer comprises a conductive agent.

3. The hard coat laminate according to claim 1, which further comprises a low refractive index layer on the outermost surface of said hard coat layer.

4. The hard coat laminate according to claim 2, wherein said conductive agent comprises one or at least two members selected from the group consisting of metals, metal oxides, metal nitrides, metal carbides, metal alkoxides, carbon compounds or carbonaceous compounds, and organic compounds.

5. The hard coat laminate according to claim 2, wherein said conductive agent is fine particles of gold.

6. The hard coat laminate according to claim 1, wherein the coverage of a liquid composition for forming said hard coat layer is not less than 3.0 g/m².

7. The hard coat laminate according to claim 1, for use as an antireflective laminate.

8. A process for producing a hard coat laminate comprising: a light transparent substrate; and an electrically conductive layer and a conductive agent-containing hard coat layer provided in that order on said light transparent substrate, said process comprising the steps of:
forming an electrically conductive layer on a surface of said light transparent substrate; and
applying a liquid composition, for hard coat layer formation, containing a conductive agent on said electrically conductive layer to form a hard coat layer, the saturated amount of electrification on the outermost surface of said hard coat laminate being brought to not more than 1.5 kV.
